(19) United States
(12) Patent Application Publication
(10) Pub. No.: US 2025/0209329 A1
(43) Pub. Date: Jun. 26, 2025

(54) REDUCTION OF STUCK CHANNELS AT A NEURAL NETWORK

(71) Applicants: ADVANCED MICRO DEVICES, INC., Santa Clara, CA (US); Xilinx AB, Stockholm (SE); Xilinx Development Corporation - Italy Branch, Milano (IT); Xilinx Ireland Unlimited Company, Dublin (IE)

(72) Inventors: Yaman Umuroglu, Trondheim (NO); Alessandro Pappalardo, Milan (IT); Jakoba Petri-Koenig, Dublin (IE); Ian Charles Colbert, San Diego, CA (US)

(21) Appl. No.: 18/389,974

(22) Filed: Dec. 20, 2023

(51) Int. Cl. G06N 3/082

(52) U.S. Cl. CPC G06N 3/082

(57) ABSTRACT

A processing system identifies and removes stuck channels in a quantized neural network (QNN), where a stuck channel is one whose outputs are always mapped to the same quantized number. The processing system identifies, at a layer of the neural network, a first channel as a stuck channel based on the first channel having a constant output. In response to identifying the first channel as a stuck channel, the processing system adjusts a first operator of the layer.

### BACKGROUND

Neural networks are employed in a wide variety of applications, including image recognition and classification, game engine design, medical imaging and analysis, and many others. The performance of a neural network frequently scales with the number of learnable parameters associated with the neural network. Accordingly, as task performance (e.g., accuracy) increases, the size of a neural network also increases. This increase in size increases the resources (e.g., compute and memory resources) consumed by the network, and makes it difficult to execute large neural networks on devices with fewer resources, such as mobile devices.

One approach to addressing the size and resource consumption of a neural network is to quantize the neural network. Quantization typically involves restricting the range and precision of the network parameters and intermediate outputs, such as the weights and activations of the network. However, many quantized neural networks (QNNs) are still relatively large and consume a relatively high number of resources.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system that identifies and removes the stuck channels of a QNN in accordance with some embodiments.

FIG. 2 is a diagram of an example of the processing system of FIG. 1 identifying a stuck channel in a layer of a QNN in accordance with some embodiments.

FIG. 3 is a diagram of an example of the processing system of FIG. 1 removing a stuck channel from a layer of a QNN in accordance with some embodiments.

FIG. 4 is a block diagram of a stuck channel reduction tool executed at the processing system of FIG. 1 in accordance with some embodiments.

FIG. 5 is a flow diagram of a method of identifying and reducing stuck channels at a QNN in accordance with some embodiments.

### DETAILED DESCRIPTION

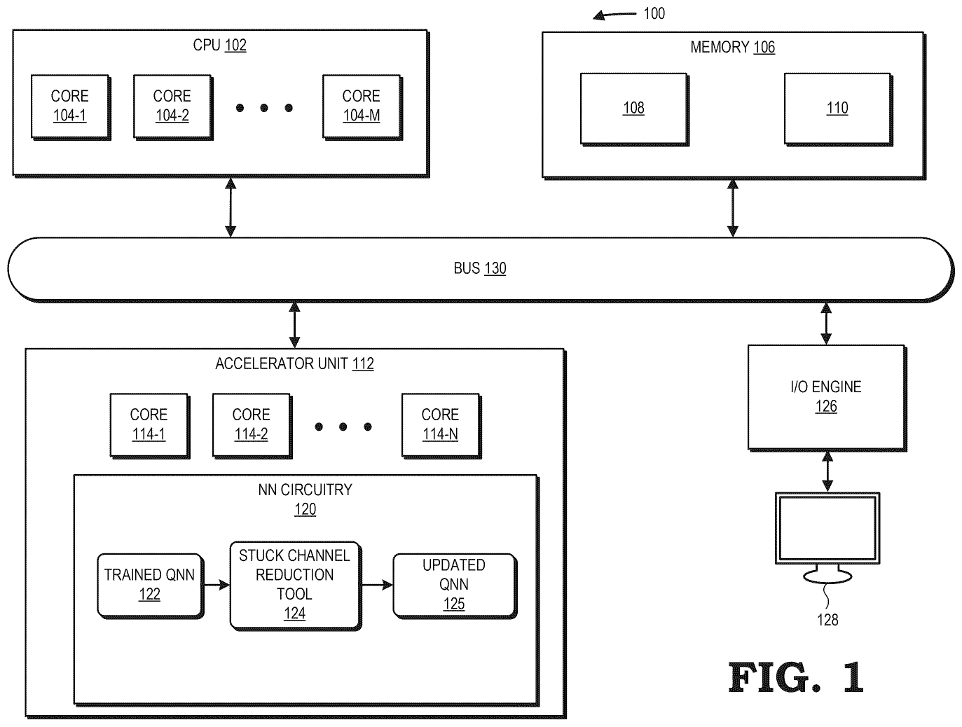

FIGS. 1-5 illustrate techniques for identifying and removing stuck channels in a quantized neural network (QNN), where a stuck channel is one whose outputs are always mapped to the same quantized number. By removing stuck channels, both the amount of memory consumed by the QNN and the overall number of calculations executed by the QNN are reduced. Thus, by identifying and removing stuck channels, the techniques described herein reduce the computation and memory resources required by a QNN, and in some cases allow a QNN to be executed on a device (e.g., a mobile device) having relatively few compute and memory resources.

To illustrate, a QNN is a neural network where the range and precision of weights and activations are limited, such as by representing all of the weights and activations in 8-bit integer (rather than single-precision floating point) format. This reduces the size of the QNN relative to a non-quantized version of the neural network, sometimes at the cost of some task performance (e.g., accuracy). In some cases, the quantization of the neural network results in a channel at a given layer of the network always being mapped to the same quantized number. To illustrate via an example, in some cases a layer of a network employs a rectified linear unit (ReLU) as an activation function that for each channel outputs the corresponding input value when the input value is positive, and otherwise outputs a constant value. When the neural network is quantized, the positive part of the ReLU becomes a stair-step function, where a range of similar inputs are mapped to the same output. In some cases, all possible inputs will fall onto the same step, and thus the channel output is always mapped to the constant value. The channel is therefore designated as a stuck channel. Because the channel output is always mapped to the same value, for any choice of inputs the final output of the neural network is not changed. Accordingly, eliminating these calculations and associated use of memory reduces overall resource consumption of the QNN without impacting task performance.

In some embodiments, the stuck channels of a QNN are identified by a software tool. The software tool receives input data in the form of a graph that defines the topology of the QNN and also defines the per-channel input range information for the QNN. The software tool performs a node-by-node walk of the topologically sorted graph representing the QNN. For each node, the software tool fetches corresponding input range information from a range library and calls a handler function to compute the output range information for the node, wherein the handler function depends on the type of operator associated with the node. The output range is stored in the library, and the computation progresses to the next node. Once all the output ranges for the channels of a layer have been calculated, the software tool determines which channels have outputs that are mapped to the same value for the entire output range (that is, that the output range is one value). The software tool identifies these channels as stuck channels.

In some embodiments, for each stuck channel at a layer, the stuck channel reduction tool modifies the operators for the layer, such as by eliminating inputs and outputs at each operator that are assigned to the stuck channel. Furthermore, if the stuck channel is mapped to a non-zero value, the software tool adds a constant bias at an output stage of the layer to add the non-zero value to the output associated with the stuck channel, so that the behavior of subsequent layers of the QNN is unchanged. The software tool thus reduces the calculations and memory resources used for the stuck channel without affecting QNN performance.

Referring now to FIG. 1, a processing system 100 configured to identify and remove the stuck channels of a QNN, in accordance with some embodiments. Processing system 100 includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. The processing system 100 also includes a bus 130 to support communication between entities implemented in the processing system 100, such as the memory 106. Some implementations of the processing system 100 include other buses, bridges, switches, routers, and the like, which are not shown in FIG. 1 in the interest of clarity.

The techniques described herein are, in different implementations, employed at accelerator unit (AU) 112. AU 112 is a processing unit including circuitry designed and configured to execute neural network operations in an accelerated fashion relative to a central processing unit (CPU) 102. Thus, in different embodiments the AU 112 is or includes, for example, vector processors, coprocessors, graphics processing units (GPUs), general-purpose GPUs (GPGPUs), non-scalar processors, highly parallel processors, artificial intelligence (AI) processors, inference engines, machine-learning processors, other multi-threaded processing units, scalar processors, serial processors, programmable logic devices (simple programmable logic devices, complex programmable logic devices, field programmable gate arrays (FPGAs), or any combination thereof.

AU 112 is configured to perform, or execute tools (e.g., software tools) that assist in performing one or more of design, configuration, training, and operation of neural networks, such as trained QNN 122. To perform these operations and execute these tools, the AU 112 implements processor cores 114-1 to 114-N that execute instructions concurrently or in parallel. For example, AU 112 executes instructions, operations, or both using processor cores 114 to execute neural network operations and tools in support thereof. In embodiments, one or more processor cores 114 of AU 112 each operate as a compute unit configured to perform one or more operations for one or more instructions received by AU 112. These compute units each include one or more single instruction, multiple data (SIMD) units that perform the same operation on different data sets to produce one or more results. For example, AU 112 includes one or more processor cores 114 each functioning as a compute unit that includes one or more SIMD units to perform operations for one or more instructions. To facilitate the performance of operations by the compute units, AU 112 includes one or more command processors (not shown for clarity). Such command processors, for example, include circuitry configured to execute one or more instructions by providing data indicating one or more operations, operands, instructions, variables, register files, or any combination thereof to one or more compute units necessary for, helpful for, or aiding in the performance of one or more operations for the instructions.

Though the example implementation illustrated in FIG. 1 presents AU 112 as having three processor cores (114-1, 114-2, 114-N) representing an N number of cores, the number of processor cores 114 implemented in AU 112 is a matter of design choice. As such, in other implementations, AU 112 can include any number of processor cores 114. Some implementations of AU 112 are used for general-purpose computing. For example, in embodiments, AU 112 is configured to receive one or more instructions, such as program code 108, from one or more applications 110 that indicate operations associated with one or more video tasks, physical simulation tasks, computational tasks, fluid dynamics tasks, or any combination thereof, to name a few. In response to receiving the program code 108, AU 112 executes the instructions for the video tasks, physical simulation tasks, computational tasks, and fluid dynamics tasks, wherein one or more of these tasks includes the execution of neural network operations, such as the configuration and training of a QNN (e.g., the trained QNN 122 and an updated QNN 125). AU 112 then stores information in the memory 106 such as the results of the executed instructions.

To assist in the design, configuration, training, and execution of neural networks, in some embodiments AU 112 includes neural network (NN) circuitry 120. NN circuitry 120, for example, is configured to execute a stuck channel reduction tool 124. In some embodiments, the stuck channel reduction tool 124 is hardware circuitry designed and configured to perform the corresponding operations described below. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In other embodiments, the stuck channel reduction tool is a set of instructions (e.g., software) executed at, for example, the processor cores 114, such that, when executed, the processor cores 114 perform the operations described herein.

The stuck channel reduction tool 124 is configured to analyze aspects of the trained QNN 122 and, based on the analysis, identify one or more stuck channels. The stuck channel reduction tool 124 is further configured to modify the aspects of the trained QNN 122 to remove one or more of the identified stuck channels, thereby generating the updated QNN 125. To illustrate, in at least some embodiments, the QNN 122 is a quantized neural network including a plurality of layers, wherein each layer includes one or more nodes, and wherein one or more nodes of each layer may implement an activation function based on inputs to the node in order to generate the node output. In some cases, the input data to a node includes a plurality of channels, representing different aspects of the overall information input to the trained QNN 122. For example, in some embodiments the trained QNN 122 receives image input data including pixel data for three different colors (e.g., red, green, blue) as well as a depth data. Accordingly, one or more nodes of the QNN 122 are configured to operate along four channels, with each channel designated for a different color or for the depth data.

To implement its assigned functionality, each node of the trained QNN 122 executes one or more mathematical operators, such as matrix multiplication (referred to as MATMUL) operators, convolution operators, addition operators, quantized activation operators such as quantized ReLU operators, or other linear-or non-linear operators. Each operator is generally configured to receive input data (e.g., from another node, from another operator of the same layer, as a set of weights for the node, or any combination thereof), perform a specified operation with the input data, wherein the operation is specified by the operator type (e.g., a MATMUL operator performs a matrix multiplication), and generates output data according to the operation. That is, each operator maps the respective input data to output data based on the operator type. As described further below, the QNN 122 only receives, for a particular channel, input data that is within a certain range, such that the operator maps all the input data to the same output because of its quantized nature. For example, in some cases an operator maps all input data below a threshold value to a constant non-zero output value. If the configuration of the QNN 122, as well as the range of possible input data for the QNN 122, is such that the operator only receives, for a given channel, input data below the threshold, the operator always maps the output data to the same value. The corresponding channel is referred to as a stuck channel for the node, because the channel is stuck to one output value for at least one operator of the node.

In at least some cases, the trained QNN 122 expends compute and memory resources to process data for a stuck channel. For example, in some cases a node performs multiplication operations that generate input data for a quantized operator that results in a stuck channel. These multiplication operations consume resources without impacting the overall behavior of the node. Accordingly, and as described further below, the stuck channel reduction tool 124 is configured to identify stuck channels at nodes of the trained QNN 122, and to modify the nodes to remove at least some of the operations associated with the stuck channel, thus generating the updated QNN 125. Because of the reduction of operations associated with stuck channels, the updated QNN 125 can execute fewer operations overall and use less memory than the trained QNN 122 but has identical task performance (e.g., classification accuracy).

In some embodiments, processing system 100 includes input/output (I/O) engine 126 that includes circuitry to handle input or output operations associated with display 128, as well as other elements of the processing system 100 such as keyboards, mice, printers, external disks, and the like. The I/O engine 126 is coupled to the bus 130 so that the I/O engine 126 communicates with the memory 106, AU 112, or the central processing unit (CPU) 102. For example, in some embodiments the circuitry of the I/O engine 126 is configured to receive input data responsive to a user's interaction with one or more input devices and provide the input data to the CPU 102. In response, the CPU 102 executes one or more operations, generates one or more commands (e.g., commands to initiate or modify operations at the AU 112), and the like, or any combination thereof. Based on the execution of one or more of the commands, the CPU 102, the AU 112, or any combination thereof provides output data to the I/O engine 126, which processes the output data and provides the processed data to one or more output devices (e.g., displays such as the display 128, audio devices, and the like).

In embodiments, processing system 100 also includes CPU 102 that is connected to the bus 130 and therefore communicates with AU 112 and the memory 106 via the bus 130. CPU 102 implements a plurality of processor cores 104-1 to 104-M that execute instructions concurrently or in parallel. In implementations, one or more of the processor cores 104 operate as SIMD units that perform the same operation on different data sets. Though in the example implementation illustrated in FIG. 1, three processor cores (104-1, 104-2, 104-M) are presented representing an M number of cores, the number of processor cores 104 implemented in CPU 102 is a matter of design choice. As such, in other implementations, CPU 102 can include any number of processor cores 104. In some implementations, CPU 102 and AU 112 have an equal number of processor cores 104, 114 while in other implementations, CPU 102 and AU 112 have a different number of processor cores 104, 114. The processor cores 104 of CPU 102 are configured execute instructions such as program code 108 for one or more applications 110 (e.g., graphics applications, compute applications, machine-learning applications) stored in the memory 106, and CPU 102 stores information in the memory 106 such as the results of the executed instructions. CPU 102 is also able to initiate neural network processing by issuing commands to AU 112.

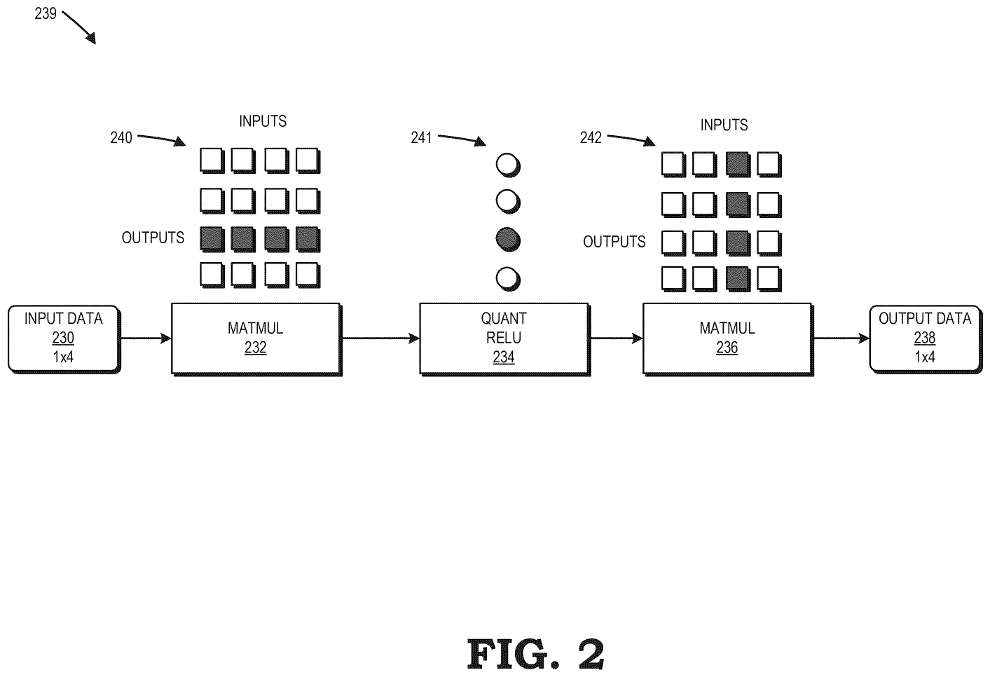

FIG. 2 illustrates an example of the stuck channel reduction tool 124 identifying a stuck channel at a node of the trained QNN 122 in accordance with some embodiments. In the depicted example, a node 239 of the trained QNN 122 is illustrated, and includes three operators: a MATMUL operator 232, a quantized ReLU operator 234, and a MATMUL operator 234. The MATMUL operator 232 is configured to receive input data 230 in the form of a 1×4 matrix, wherein each element of the matrix is data for a different channel of the trained QNN 122. The MATMUL operator 232 performs a matrix multiplication operation with the input data 230 and a first set of weights, illustrated as a matrix 240, and provides the results of the multiplication to the quantized ReLU operator 234.

The quantized ReLU operator 234 is configured to receive the output data from the MATMUL operator 232 and perform the quantized rectified linear unit operation on the received data. For purposes of describing the example of FIG. 2, it is assumed that the input to the quantized ReLU operator 234 is always between 10 and 100, and the input range between 10 and 100 is mapped to an output value of 1. In particular, the quantized ReLU operator 234 provides a constant output (e.g., an output value of 1) for a channel because the input data for that channel is within a certain range (e.g., between 10 and 100).

The MATMUL operator 236 is configured to receive output data from the ReLU operator 234. The MATMUL operator 232 performs a matrix multiplication operation with the input data and a second set of weights, illustrated as a matrix 242, and provides the results of the multiplication as the output data 238, representing the output data for the node 239.

FIG. 2 further illustrates the output data for each of the operators 232, 234, and 236, based on the range of the corresponding input data. As described further herein, the data for an operator is shown as a filled polygon (a filled square or circle) when that data falls within a particular range that results in a stuck channel, and as a clear or unfilled polygon when the data is outside that range. Thus, for the MATMUL operator 232, an input/output matrix 240 is shown, indicating the weights for a carrying out weighted summation for a set of input data. Each row of the matrix 240 indicates the output for a corresponding channel. Thus, for the example of FIG. 2, it is assumed that the input data 230 has a range (from the minimum expected input data for each channel to the maximum expected input data for each channel) such that, after the multiplication and summation operations by the MATMUL operator 232, the first, second, and fourth output channels have output data that, at least in some cases, will be mapped by the quantized ReLU operator 234 to values less than 10 or greater than 100. In contrast, the combination of matrix weights 240 and range of the input data 230 is such that the output of the third channel is always mapped to a value between 10 and 100, as indicated by the filled squares in the third row of the matrix 240.

The circles above the quantized ReLU operator 234 in FIG. 2 illustrate an output matrix 241, representing the range of outputs of the ReLU operator 234 based on the corresponding input ranges illustrated at matrix 240. In particular, the filled circle for channel three at the matrix 241 indicate that the only output provided for channel three is the fixed constant value generated by the quantized ReLU operator 234, and the unfilled or clear circles for channels one, two, and four indicate that the outputs for these channels vary according to the corresponding input values and are not fixed to the constant value. In other words, because the input to channel three is always within the range of the same stair-step for the quantized ReLU operator 234 (as indicated by the matrix 240), the output for channel three by the ReLU operator is always mapped to the constant value.

For the MATMUL operator 236, a weight matrix 242 is shown, indicating the range of output data for a corresponding set of input data. In the depicted example, because the output of the quantized ReLU operator 234 is always mapped to the constant value, the third input channel of the MATMUL operator 236 is always the same value, as illustrated by the filled squares in the third column of the matrix 242. In other words, under the specified ranges for the input data 230, each of the output channels for MATMUL 236 get a fixed contribution that does not vary with the input. The third input channel for MATMUL 236, hereafter referred to as the third channel for brevity, is therefore a stuck channel.

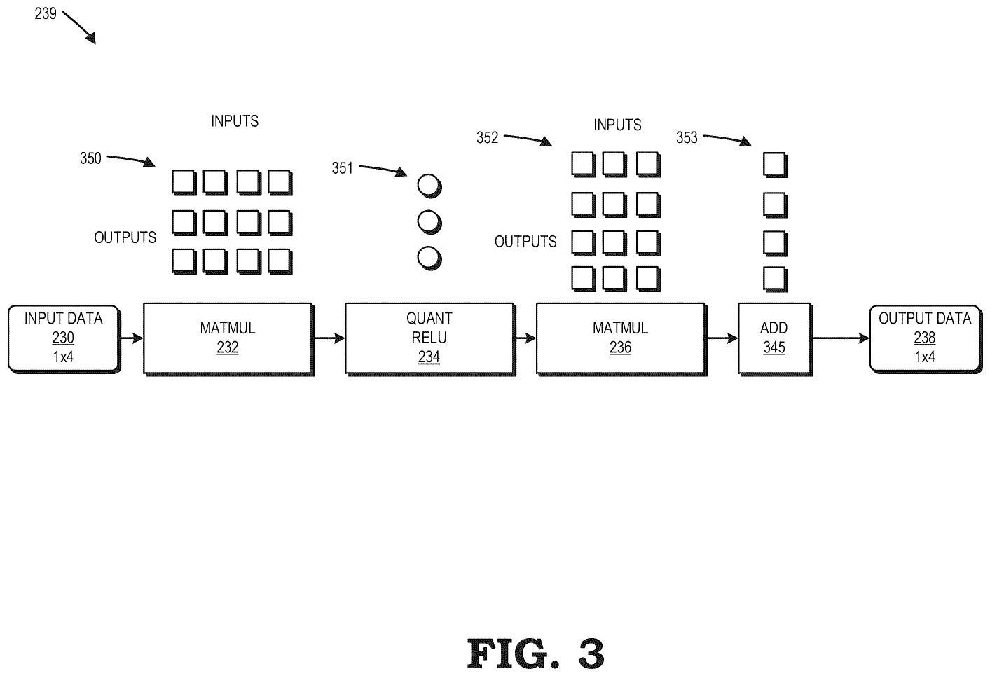

The stuck channel reduction tool 124 is generally configured to identify the range of input at each node of the trained QNN 122 based on a specified range of input data. For each operator, the stuck channel reduction tool 124 determines whether the corresponding range of input data would result in output data that is results in a stuck channel, as described further below. In some embodiments, the stuck channel reduction tool 124 then modifies nodes that have stuck channels to reduce mathematical operations associated with the stuck channel. An example is illustrated at FIG. 3 in accordance with some embodiments.

In particular, FIG. 3 illustrates modifications to the node 239 after the stuck channel reduction tool 124 has determined that the third channel is a stuck channel. In the depicted example, the stuck channel reduction tool has modified the trained QNN 122 so that the MATMUL operator 232, the quantized ReLU operator 234, and the MATMUL operator 236 do not perform the corresponding operations for the third channel. This is illustrated by matrices 350, 351, and 352. In particular, matrix 350 indicates that MATMUL operator 232 only produces three outputs, rather than four. In other words, the MATMUL operator 232 only performs the matrix multiplication operations required to generate output values for three, rather than four channels. Similarly, the matrix 351 indicates the output values generated by the quantized ReLU operator 234, and includes only three rows to indicate that the quantized ReLU operator 234 only performs operations for the first, second, and fourth channels. Finally, matrix 352 indicates that MATMUL operator 236 only receives three input values, and thus does not perform any multiplication operations for the third channel.

It will be appreciated that the operations for each of the operators 232, 234, and 236 are executed at the accelerator unit 112 (e.g., at the cores 114, at the NN circuitry 120, or any combination thereof). Accordingly, by eliminating the operations at each of the operators 232, 234, and 236, the stuck channel reduction tool 124 reduces the number of executions at the hardware of the accelerator unit 112 for the corresponding QNN, thus conserving compute resources. Furthermore, the amount of memory space (e.g., register space, buffer space, and the like) needed to store data for the operators 232, 234, and 236 is reduced, thus conserving memory resources.

In addition to reducing operations at the operators 232, 234, and 236 for the stuck channel, the stuck channel reduction tool 124 adds an ADD operator 345 to the node 239. The ADD operator 345 is configured to add a bias value, represented by matrix 353, to the third channel at the node 239. The values of the matrix 353 are set to be equivalent to the stuck value for the third channel, multiplied by the respective weight from the third column of matrix 242. That is, the values are set to be equivalent to the fixed contribution of the third channel on the outputs of MATMUL 236. This ensures that the output data 238 for the node 239 remains the same after modification by the stuck channel reduction tool 124. Thus, the stuck channel reduction tool 124 reduces the operations associated with a stuck channel without changing the behavior of the nodes, and thus without changing the overall behavior of the neural network.

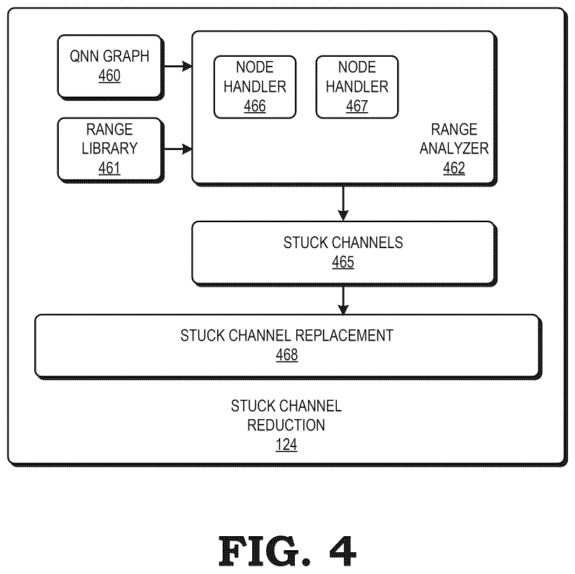

FIG. 4 illustrates a block diagram of an example of the stuck channel reduction tool 124 in accordance with some embodiments. In the illustrated embodiment, the stuck channel reduction tool 124 includes a QNN graph 460, a range library 461, a range analyzer 462, a stuck channels record 465, and a stuck channel replacement tool 468. In some embodiments, the range analyzer 462 and the stuck channel replacement tool 468 are hardware circuitry designed and configured to perform the corresponding operations described below. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In other embodiments, one or more of the range analyzer 462 and the stuck channel replacement tool 468 is a set of instructions (e.g., software) executed at, for example, the processor cores 114, such that, when executed, the processor cores 114 perform the operations described herein.

The QNN graph 460 is a topologically sorted graph representing the trained QNN 122. Thus, in some embodiments, the QNN graph 460 describes the layers, channels, and nodes of the QNN 122 in a topologically sorted form that is suitable to be traversed by layer, channel and node. The range library 362 stores range information for inputs to the nodes of the QNN 122. Initially, the range library 362 stores the range of input data for each node of an initial layer of the QNN 122. In some embodiments, the initial range of input data is specified according to the expected range of inputs for the QNN 122 during normal operation or implementation.

The range analyzer 462 is a tool generally configured to perform a node-by-node walk of the QNN graph 460. For each node, the range analyzer 462 fetches input range information from the range library 362. The range analyzer 462 then calls a handler (e.g., handler 466, 467) to compute the corresponding range of outputs for the node, and then stores the range of outputs at the range library 362. The range analyzer 462 continues to traverse the QNN graph 460 until the output range for each node of the QNN 122 has been determined.

In some embodiments, the particular handler called by the range analyzer 462 depends on the type of node for which the output range is being determined. For example, in some embodiments the QNN graph 460 identified each node as one of a monotonic node, a dot product node, and a special node. For all of the monotonic nodes, the range analyzer 462 calls a monotonic node handler—in other words, all monotonic nodes are processed with the same handler (e.g., handler 466). Similarly, all dot product nodes are processed with the same dot product handler (e.g., handler 467). Special nodes are each processed with a specific corresponding handler based on the specified behavior of the node. For example, to analyze a Softmax node the range analyzer calls a Softmax handler.

In some embodiments, monotonic nodes are those nodes that are elementwise monotonic. Examples include ReLU nodes, sigmoid activation nodes, concatenation nodes, batch normalization nodes, elementwise and channelwise addition and multiplication nodes, clipping nodes, max nodes, and average pooling nodes. The handler for the monotonic nodes determines the output range for the node by making a list of candidate input vectors, which are constructed by combining the min/max of each input, resulting in 2d candidates, where d is the number of dynamic inputs. For instance, a batch normalization layer with fixed statistics and parameters would have d=1. Each candidate is processed (that is, the node operators are executed, or their execution is simulated) to produce the corresponding outputs. The handler then reduces these outputs via minimum/maximum functions to determine the per-channel output range, which the range analyzer 462 stores at the range library 461.

For dot product nodes, such as fully-connected or convolutional layers, the handler employs minimizing and maximizing input vectors. To construct the minimizing input vector, the handler determines the maximum of the input range for each negative weight, and the minimum for each positive weight. The handler determines the minimizing input vector by determining the minimum of the input range for each negative weight and the maximum for each positive weight. To obtain the range of the outputs, the handler performs the dot product of the weights with the minimizing and maximizing input vectors. The range analyzer 462 stores the output range at the range library 461.

After identifying the output ranges for each node, the range analyzer 462 determines which nodes have stuck channels. For example, in some embodiments the range analyzer determine which nodes have operators wherein a minimum output value for the operator matches the maximum output for the operator. If so, the range analyzer 462 identifies that channel as being a stuck channel for the node, and stores an identifier for the channel and the node at the stuck channels record 465.

The stuck channel replacement tool 468 accesses the stuck channels record 465 to determine the stuck channels at the trained QNN 122. The stuck channel replacement tool 468 then modifies one or more of the operators at one or more of the stuck channels to reduce operations for the stuck channel. In addition, the stuck channel replacement tool 468 adds biases to the stuck channels to add the stuck channel value as a bias to the corresponding node. Thus, the stuck channel replacement tool 468 manipulates the node parameters and outputs in a way that preserves the original computation with the stuck channel value.

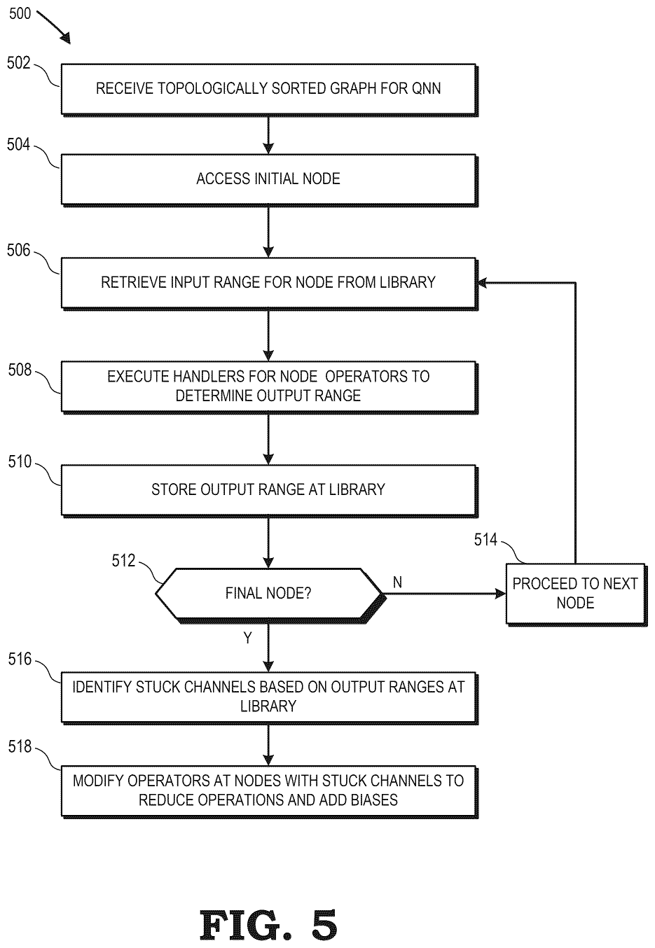

FIG. 5 illustrates a flow diagram of a method 500 of identifying stuck nodes at a QNN and modifying nodes associated with a stuck channel in accordance with some embodiments. For purposes of description, the method 500 is described with respect to an example implementation at the processing system 100 of FIG. 1, and in particular the stuck channel reduction tool 124 illustrated at FIG. 4, but in other embodiments the method 500 is implemented at a processing system having a different configuration, such as any processing system that implements a neural network at a CPU, one or more vector processors, coprocessors, graphics processing units (GPUs), general-purpose GPUs (GPGPUs), non-scalar processors, highly parallel processors, artificial intelligence (AI) processors, inference engines, machine learning processors, other multithreaded processing units, scalar processors, serial processors, programmable logic devices (simple programmable logic devices, complex programmable logic devices, field programmable gate arrays (FPGAs), or any combination thereof.

At block 502, the range analyzer 462 accesses the QNN graph 460, which is a topologically sorted graph representing the nodes, and connections between nodes, for the trained QNN 122. In some embodiments, the QNN graph 460 is a graph that is represented in ONNX format and can be compiled by supported frameworks such as QONNX, FINN, MLIR or MIGraphX. At block 504, the range analyzer 462 selects an initial node of the QNN 122, as indicated by the QNN graph 460.

At block 506, the range analyzer 462 retrieves the input range for the selected node from the range library 461. In some embodiments, the range library 461 is a data structure (e.g., an array, linked list, tree, table, and the like) including a number of entries, wherein each entry corresponds to an operator of a node. Furthermore, each entry stores both the minimum input value and the maximum input value for the operator. For the initial operators of the QNN 122 (e.g., the initial operators at the nodes of an initial layer of the QNN 122), the minimum and maximum output values are specified based on the expected range of input data for the QNN 122 and are stored at the range library 461 during an initialization phase of the stuck channel reduction tool 124. The minimum and maximum input values for subsequent operators in the topology of the QNN 122 are set by the range analyzer 462 to the calculated minimum and maximum output values of the previous operator (that is, the operator, or operators, having outputs connected to the inputs of the current operator), wherein the calculation of the outputs is described further below.

At block 508, for each operator of the selected node, the range analyzer 462 selects and executes a corresponding handler. Each handler for an operator, when executed, generates the maximum and minimum output values for the operator based on the minimum input and output for the operator. At block 510, the range analyzer 462 stores the output range for each operator of the selected node at the range library 461.

At block 512, the range analyzer 462 determines whether the selected node is the final node for the QNN 122. If not, the method flow moves to block 514 and the range analyzer 462 selects the next node according to the topology indicated by the QNN graph 460. The method flow returns to block 506 and the range analyzer 462 determines the range for the selected node as described above.

Returning to block 512, if the range analyzer 462 has determined the output range for all of the operators of the QNN 122, the method flow moves to block 516 and the range analyzer 462 determines which nodes of the QNN 122 have stuck channels. For example, in some embodiments the range analyzer 462 accesses the range library 561 and determines, based on the stored minimum and maximum outputs, which operators always map input values for a channel to the same output value for the channel. In particular, the range analyzer determines that the operator has a stuck channel when the minimum and maximum outputs are the same value. The range analyzer 462 stores identifiers for the nodes that have stuck channels at the stuck channels record 465. At block 518, the stuck channel replacement tool 468 modifies one or more of the operators at one or more of the stuck channels to reduce operations for the stuck channel. In addition, the stuck channel replacement tool 468 adds constant biases to the remaining channels as a replacement for the stuck channel value that is being removed.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations) or a programmable circuit (e.g., a corresponding portion of a field programmable gate array (FPGA) or programmable logic device (PLD)). In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry, etc.) are described or claimed as “configured” to perform one or more tasks or operations. This formulation-[entity] configured to [perform one or more tasks]—is used herein to refer to structure (i.e., something physical, such as electronic circuitry). More specifically, this formulation is used to indicate that this physical structure is arranged to perform the one or more tasks during operation. A structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
at a layer of a neural network, identifying a first channel as a stuck channel based on the first channel having a constant output; and
in response to identifying the first channel as a stuck channel, adjusting a first operator of the layer.

2. The method of claim 1, wherein adjusting the first operator comprises:
eliminating at least one operation at the first operator.

3. The method of claim 2, wherein the at least one operation comprises a multiply operation.

4. The method of claim 2, further comprising:
in response to identifying the first channel as a stuck channel, adjusting a second operator of the layer.

5. The method of claim 4, wherein the first operator is a quantized or non-quantized operator, and the second operator is a quantized operator.

6. The method of claim 5, wherein the first operator provides data to an input of the second operator.

7. The method of claim 5, wherein the second operator provides data to an input of the first operator.

8. The method of claim 1, further comprising:
in response to identifying the first channel as a stuck channel, adding a second operator to the layer of the neural network.

9. The method of claim 8, wherein adding the second operator comprises:
adding the second operator to add a bias, the bias being equivalent to the constant output.

10. The method of claim 1, further comprising:
identifying the first channel has the constant output based on application of a range of input values to the first channel.

11. The method of claim 10, wherein identifying the first channel has the constant output comprises:
applying the range of input values to a first operator of the layer to generate a first range of output values;
applying a minimum and maximum of the first range of output values as inputs to a second operator to generate a second range of output values; and
identifying the first channels has the constant output based on the second range of output values.

12. A non-transitory computer readable medium embodying a set of executable instructions, the set of executable instructions to manipulate at least one processor to:
at a layer of a neural network, identify a first channel as a stuck channel based on the first channel having a constant output; and
in response to identifying the first channel as a stuck channel, adjust a first operator of the layer.

13. The non-transitory computer readable medium of claim 12, wherein the instructions to adjust the first operator comprise instructions to:
eliminate at least one operation at the first operator.

14. The non-transitory computer readable medium of claim 13, wherein the at least one operation comprises a multiply operation.

15. The non-transitory computer readable medium of claim 13, further comprising instructions to:
in response to identifying the first channel as a stuck channel, adjust a second operator of the layer.

16. The non-transitory computer readable medium of claim 15, wherein the first operator is a non-quantized operator and the second operator is a quantized operator.

17. The non-transitory computer readable medium of claim 12, further comprising instructions to:
in response to identifying the first channel as a stuck channel, add a second operator to the layer of the neural network.

18. The non-transitory computer readable medium of claim 17, wherein the instructions to add the second operator comprise instructions to:
add the second operator to add a bias, the bias being equivalent to the constant output.

19. The non-transitory computer readable medium of claim 12, further comprising instructions to:
identifying the first channel has the constant output based on application of a range of input values to the first channel.

20. A system comprising:
a bus;
a first processing unit to send a command via the bus;
a second processing unit, in response to the command, to:
at a layer of a neural network, identify a first channel as a stuck channel based on the first channel having a constant output; and
in response to identifying the first channel as a stuck channel, adjust a first operator of the layer.
